(19) United States
(12) Patent Application Publication
(10) Pub. No.: US 2012/0193594 A1
(43) Pub. Date: Aug. 2, 2012

(54) PERIMETER ACCESS CONTROL SYSTEM AND METHOD FOR USE THEREOF

(76) Inventor: Ralph Glenn McAfee, La Plata, MD (US)

(21) Appl. No.: 13/017,737

(22) Filed: Jan. 31, 2011

(51) Int. Cl. B23Q 3/00; E04H 17/06

(52) U.S. Cl. 256/43; 256/32; 29/467

(57) ABSTRACT

A system for perimeter access control and a method for use thereof is disclosed. The system includes a plurality of posts positioned around a secured area and a portable base station with a lockable storage cavity. Within the storage cavity is located at least one drum of fencing. A first portion of fencing is paid out from the at least one drum and is wrapped around the plurality of posts and then secured within the lockable storage cavity to form a fenced perimeter around the secured area. The method for use of the perimeter access control system includes positioning the plurality of posts around the secured area; positioning the portable base station proximate the secured area; unwinding the first portion of fencing from the at least one drum; wrapping the first portion of fencing around the plurality of posts; and securing both ends of the first portion of fencing within the portable base station.

### BACKGROUND OF THE INVENTION

1. Field of the Invention

The present invention is generally related to a system for prohibiting access to a protected area. More particularly, the present invention is related to a system for providing a fenced perimeter surrounding a protected area to prohibit access thereto. More specifically, the present invention is related to a system providing a portable fencing system for defining a fenced perimeter used to secure a temporary fall protection system around a protected area.

2. Description of the Prior Art

Construction jobsites contain various hazards and areas requiring restricted access. For example, individuals require protection from entering demolition areas of construction jobsites containing injury inducing dangers. During construction, individuals also require protection from incomplete areas of construction jobsites. Such incomplete areas can include balconies, elevator shafts, skylights, slab edges, and stairwells. Similarly, mechanical areas of construction jobsites can contain valuable equipment that require restricted access to provide protection from theft.

Therefore, there is a need for a temporary system for prohibiting access to a protected area. Such a system can be portable, and provide for a fenced perimeter surrounding a protected area to guard individuals from entry.

### SUMMARY OF THE INVENTION

The present invention in one preferred embodiment contemplates a perimeter access control system having a plurality of posts positioned around a secured area, and a portable base station including a first side and a second side, a lockable storage cavity, at least one drum of cable stored within the lockable storage cavity, a first strand of cable paid out from the at least one drum and wrapped around each of the plurality of posts, and a second strand of cable paid out from the at least one drum and wrapped around each of the plurality of posts, the first and second strands of cable extending from the first side to the second side around each of the plurality of posts to form a fenced perimeter around the secured area, and ends of the first and second strands of cable being secured to the lockable storage cavity. The preferred embodiment of the perimeter access control system should be sufficiently sized and robust enough to establish a fenced perimeter that satisfies all the requirements of 29 C.F.R. §1926.502, which is hereby incorporated by reference.

The present invention in a further preferred embodiment contemplates a method of forming a fenced perimeter around a secured area including positioning a plurality of posts around the secured area; positioning a portable base station proximate the secured area, the portable base station including at least one drum of cable stored therein; unwinding a first strand of cable from the at least one drum, and wrapping the first strand of cable around the plurality of posts; unwinding a second strand of cable from the at least one drum, and wrapping the second strand of cable around the plurality of posts; attaching the first and second strands of cable to each of the plurality of posts; and after the first and second strands are wrapped around the plurality of posts, securing ends of the first and second strands of cable to the portable base station.

It is understood that both the foregoing general description and the following detailed description are exemplary and exemplary only, and are not restrictive of the invention as claimed.

### BRIEF DESCRIPTION OF THE DRAWINGS

The accompanying drawings, which are incorporated in and constitute a part of the specification, illustrate preferred embodiments of the invention. Together with the description, they serve to explain the objects, advantages and principles of the invention. In the drawings:

FIG. 1 is a perspective view depicting an environment in which one embodiment of the system according to the present invention is used on a jobsite;

FIG. 2 is a rear elevational view of a base station used in the embodiment of the present invention depicted in FIG. 1 with a door thereof in an opened position;

FIG. 3 is a cross-sectional view of the base station of FIG. 2 taken along Line A-A thereof;

FIG. 4 is a side elevational view of the base station of FIG. 2 with the door thereof in the closed position and a safety post positioned in the rear of the base station;

FIG. 5 is a front elevational view of the base station of FIG. 2 with the door thereof in the closed position;

FIG. 6 is a side elevational view of a safety post used with one embodiment of the present invention; and

FIG. 7 is a side elevation view of the base station of FIG. 2 with the door thereof in the closed position and with a plurality of safety posts stored thereon.

### DETAILED DESCRIPTION OF THE PREFERRED EMBODIMENT

The following description is intended to be representative only and not limiting and many variations can be anticipated according to these teachings. Reference will now be made in detail to the preferred embodiments of this invention, examples of which are illustrated in the accompanying drawings.

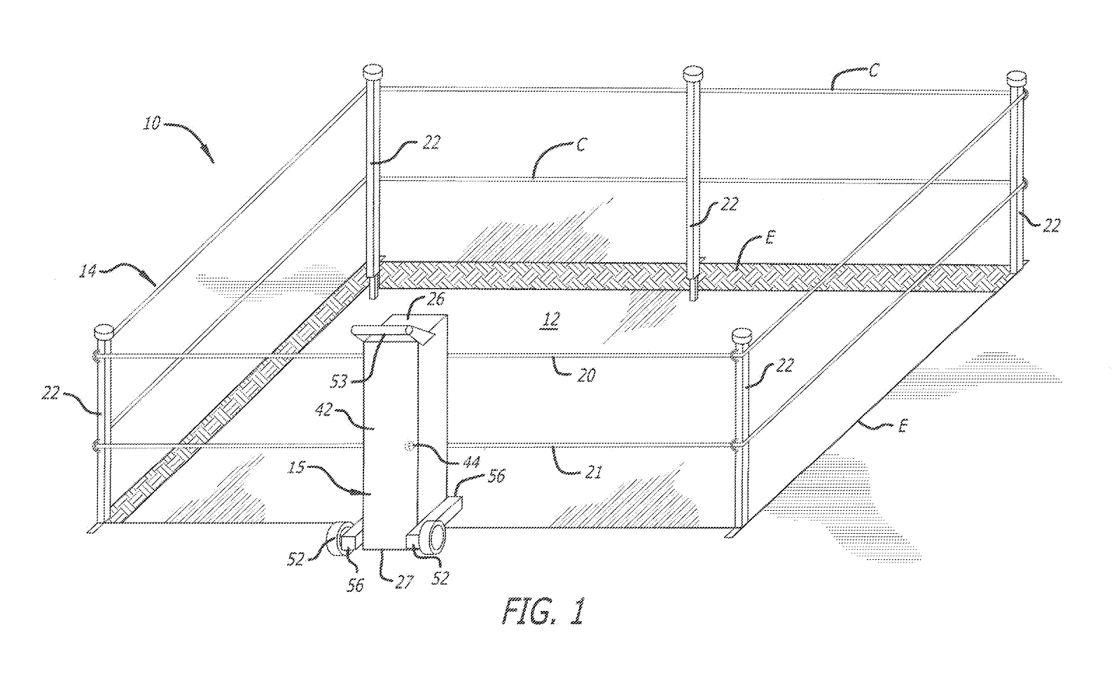

FIG. 1 depicts a perimeter access control system according to one preferred embodiment of the present invention which is generally indicated by the numeral 10. System 10 is used in securing access to a protected area, for example, indicated by the numeral 12 in FIG. 1. In doing so, system 10 defines a fenced perimeter 14 surrounding protected area 12. Fenced perimeter 14 afforded by system 10 serves in guarding individuals from falling into or otherwise entering protected area 12.

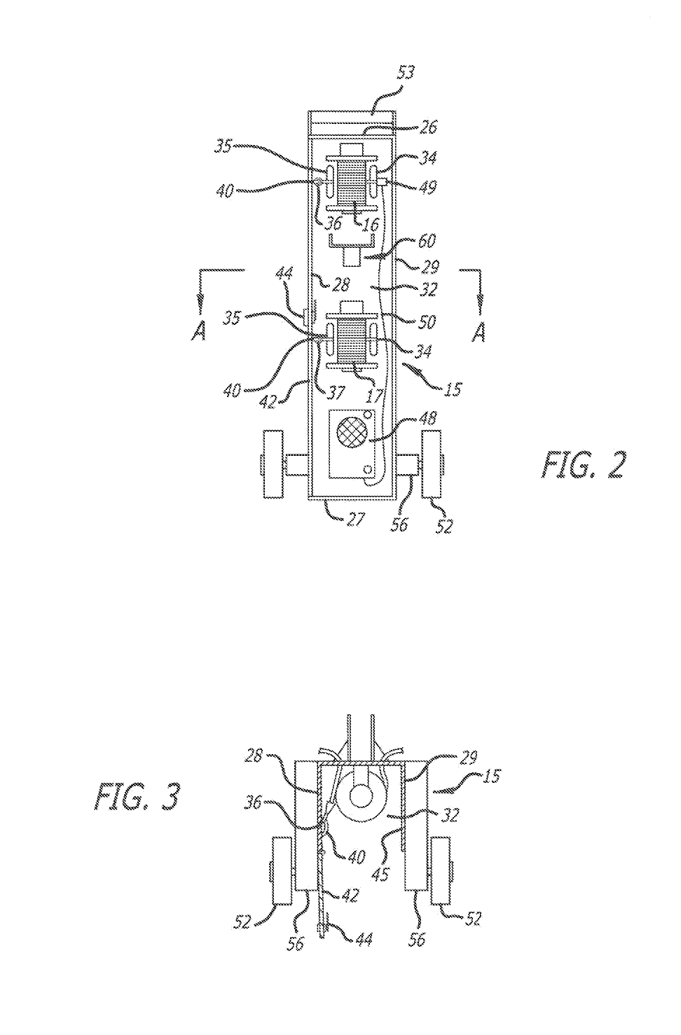

The system 10 includes a base station 15. Base station 15 serves in part as a storage locker for storing some of the components of system 10. As discussed below, base station 15 is portable, and thus, can be positioned at the edge E of protected area 12. To facilitate formation of fenced perimeter 14, base station 15 includes at least one drum of fencing material mounted thereto. For example, the fencing material can be mesh fencing or cable C (FIG. 1). As depicted in FIG. 1, first and second strands 20 and 21 of cable C are used in forming fenced perimeter 14. First and second strands 20 and 21 can be provided on one drum, but, as depicted in FIG. 2, base station 15 includes first and second drums 16 and 17 of first and second strands 20 and 21 of cable C.

As depicted in FIG. 1, first and second strands 20 and 21 of cable C are wrapped around safety posts 22 to form fenced perimeter 14. As discussed below, safety posts 22 are positioned around protected area 12, and first and second strands 20 and 21 are paid out from first and second drums 16 and 17 stored within base station 15. When tensioned, first and second strands 20 and 21 serve in guarding individuals from falling or otherwise passing through fenced perimeter 14 into protected area 12. Optionally, first and second drums 16 and 17 may include a spring loaded tensioning system to enable self-tensioning of cable C. Alternatively, the first and second drums 16 and 17 may be equipped with a ratcheting mechanism capable of tensioning cable C when the system is installed.

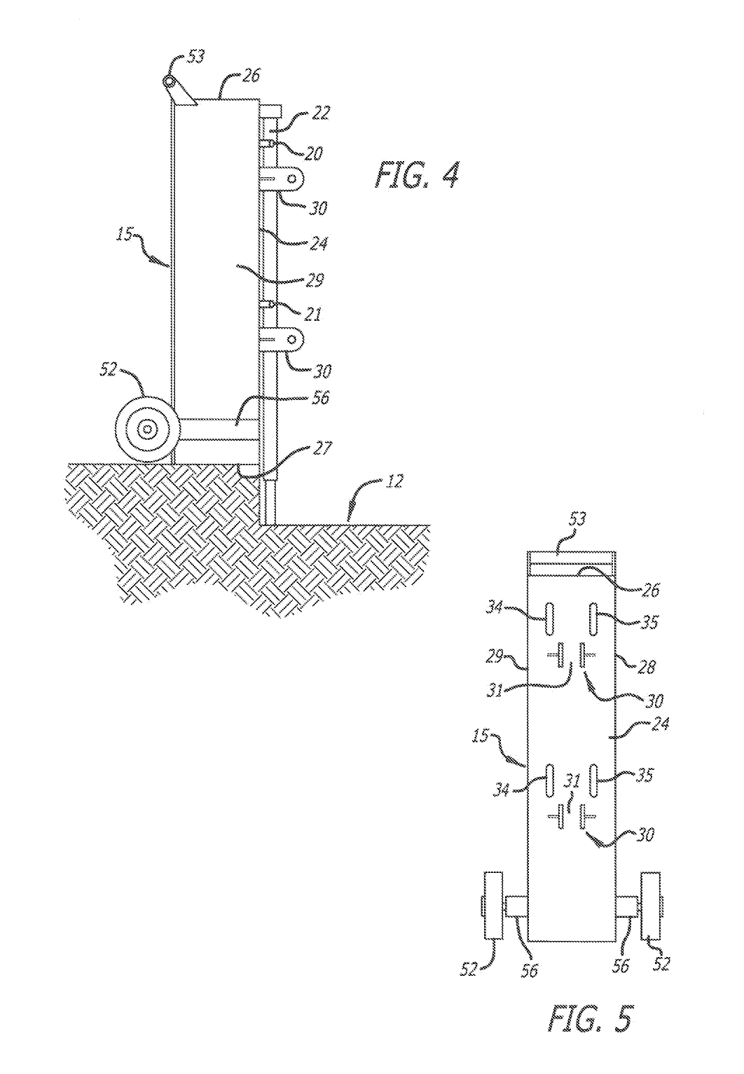

As depicted in FIGS. 2-5, base station 15 includes a front wall 24, a top wall 26, bottom wall 27, and opposed sidewalls 28 and 29. As depicted in FIGS. 4 and 5, brackets 30 are attached to front wall 24. Brackets 30 include opposed portions defining a cavity 31 for securably receiving one of safety posts 22 therein. As such, one of safety posts 22 can be attached to base station 15 using brackets 30. Thus, when positioned at the edge E of protected area 12, base station 15 can be secured in position via attachment to one of safety posts 22 positioned adjacent protected area 12.

Front wall 24, top wall 26, bottom wall 27, and opposed sidewalls 28 and 29 define a cavity 32 for containing first and second drums 16 and 17. First and second drums 16 and 17, as depicted in FIG. 2, are mounted on front wall 24 within cavity 32. Slots 34 and 35 are formed through front wall 24 on both of the sides of first and second drums 16 and 17. First and second strands 20 and 21 are paid out through slots 34. Once first and second strands 20 and 21 are wrapped around safety posts 22 to form a fence, ends 36 and 37 of first and second strands 20 and 21, respectively, are received through slots 35. Ends 36 and 37 are then secured to base station 15. As depicted in FIG. 2, ends 36 and 37 can be secured within cavity 32. Ends 36 and 37 can be looped and/or include fasteners (such as, for example, karabiners) to facilitate attachment to attachment points 40 within cavity 32. Alternatively, both ends 36 and 37 may be attached to a handle (not shown) that is paid out through slot 35 and received through slot 34. The handle may be secured on hooks located within cavity 32, thereby enabling a user to simultaneously wrap and secure both strands 20 and 21 around safety posts 22.

Access to cavity 32 can be restricted by a door 42 provided between opposed sidewalls 28 and 29. As depicted in FIG. 3, one side of door 42 is hingedly attached to opposed sidewall 28, and door 42 can be locked in a closed position using a lock 44 provided on the other side thereof. Lock 44 can be latched to a lip 45 provided on opposed sidewall 29. In the closed position, door 42 prohibits access to cavity 32 containing first and second drums 16 and 17 and corresponding cable C. Thus, lock 44 effectively prevents ends 36 and 37 from being released from attachment points 40. Lock 44 also prevents the option cable tensioning mechanisms of first and second drums 16 and 17 from being released. Therefore, access to restricted area 12 cannot be gained without damaging system 10.

Preferably, the key to lock 44 will be maintained by management in the jobsite office. Access to the key would only be provided to a responsible party upon signing an access log. Accordingly, upon signing out the key, the responsible party would assume responsibility for safeguarding the protected area while the system is removed and for the proper reinstallation thereof when finished.

An alarm 48 can also be provided to sound if tension in first and second strands 20 and 21 is released. Alarm 48 can be housed within cavity 32, and can include a strain gage 49 attached to either of first and second strands 20 and 21. Alarm 48 is attached to strain cage 49 via an electrical connection 50. As depicted in FIG. 2, strain gage 49 is attached to first strand 20. Thus, if tension in first strand 20 is significantly diminished (e.g., when first strand 20 is cut or removed from any of safety posts 22, or any of safety posts 22 are moved to gain access), alarm 48 will sound a warning. Furthermore, the warning could be provided by flashing lights (not shown) placed around protected area 12. Either way, alarm 48 provides a warning when first strand 20, or any of the safety posts 22 are tampered with. Alarm 48 may be configured to automatically set when lock 44 is engaged, or it may be configured to require separate setup.

Safety posts 22, as depicted in FIG. 1, can be placed along the edge E of protected area 12 at and in between the corners thereof. The number and placement of safety posts 22 will depend on the shape of protected area 12. Furthermore, safety posts 22 can be provided at the jobsite and/or can be provided with base station 15. For example, base station 15 can include racks 56 attached to sidewalls 28 and 29 for transport to the jobsite.

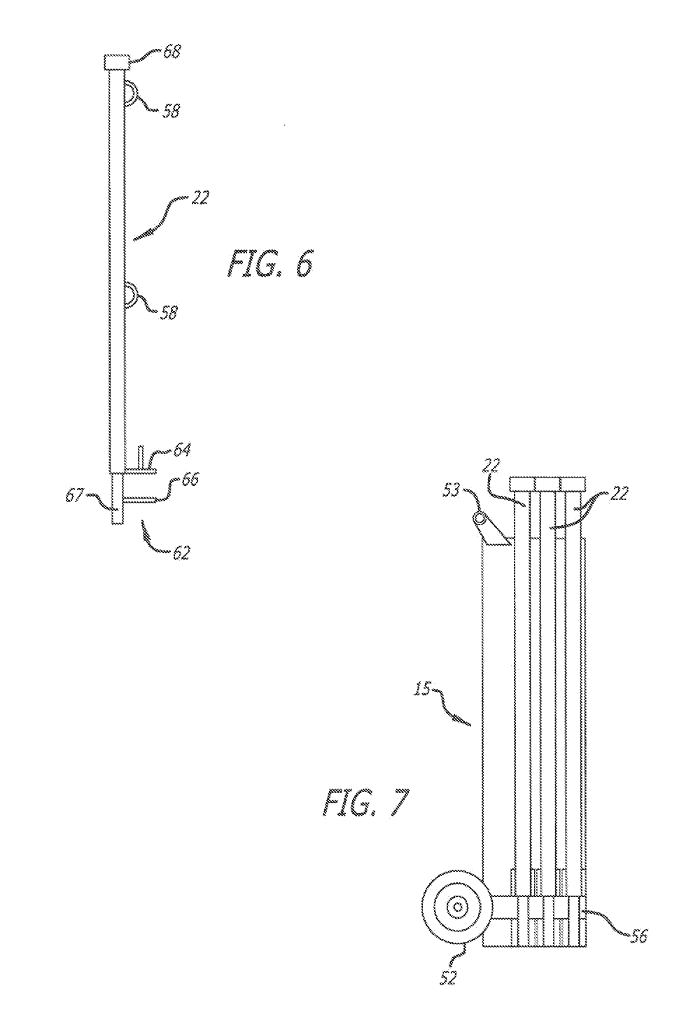

Safety posts 22 each include eyelets 58 (FIG. 6) for receiving first and second strands 20 and 21 therethrough. As depicted in FIG. 1, the spacing of eyelets 58 apart from one another corresponds to the desired spacing between first and second strands of cable 20 and 21. If necessary, additional eyelets 58 can be provided to accommodate additional strands of cable C. Eyelets 58 serve as points of attachment for securing first and second strands of cable 20 and 21 to safety posts 22, and can be integrally formed with safety posts 22. As such, eyelets 58 serve to resist removal of first and second strands of cable 20 and 21 from safety posts 22. Thus, without releasing first and second strands of cable 20 and 21 from within base station 15, strands 20 and 21 cannot be removed from safety posts 22 without damage thereto. Optionally, eyelets 58 may include closeable openings in the perimeter thereof to permit easier insertion of strands 20 and 21 therethrough.

Safety posts 22 can be removably attached to the edge E of protected area 12 using a specialized tool 60 and clamping assemblies 62 provided adjacent the bottoms of safety posts 22. Specialized tool 60 is ultimately stored within base station 15, and can be used to actuate clamping assemblies 62. Each of clamping assemblies 62 includes a fixed clamping portion 64, a moveable clamping portion 66, and an actuation mechanism (a rod 67 of which is shown in FIG. 6) for moving moveable clamping portion 66 with respect to fixed clamping portion 64. Besides rods 67, the remainders of the actuation mechanisms are provided internal to safety posts 22. Access to the actuation mechanisms is provided by removable caps 68 provided at the tops of safety posts 22. Via actuation of the actuation mechanisms with specialized tool 60, moveable clamping portions 66 can be drawn toward fixed clamping portions 64 to clamp the edge E of protected area 12 therebetween. Specialized tool 60 and storage thereof within based station 15 prevents tampering with clamping assemblies 62 of safety posts 22. To facilitate portability thereof, base station 15 includes wheels 52 attached to each of racks 56 of opposed sidewalls 28 and 29. Furthermore, a handle 53 is attached to opposed sidewalls 28 and 29 adjacent top wall 26 to facilitate manipulation of base station 15. Accordingly, wheels 52 and handle 53 allow base station 15 to be positioned adjacent the edge of protected area 12.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A perimeter access control system comprising:
a plurality of posts positioned around a secured area; and
a portable base station including a first side and a second side, a lockable storage cavity, at least one drum of fencing stored within the lockable storage cavity, and a first portion of fencing paid out from said at least one drum and wrapped around each of said plurality of posts, said first portion of fencing extending from said first side to said second side around each of said plurality of posts to form a fenced perimeter around the secured area, and both ends of said first portion of fencing being secured within said lockable storage cavity.

2. The perimeter access control system of claim 1, further comprising a second portion of fencing.

3. The perimeter access control system of claim 2, wherein said first and second portions of fencing comprise a first cable and a second cable, respectively.

4. The perimeter access control system of claim 1, wherein at least one of said plurality of posts includes a clamping portion for securing said at least one post proximate the secured area.

5. The perimeter access control system of claim 1, wherein said plurality of posts each include at least one eyelet for securing said first portion of fencing therein.

6. The perimeter access control system of claim 1, wherein said plurality of posts may be stored on said portable base station.

7. The perimeter access control system of claim 1, wherein said portable base station includes wheels for the transportation thereof.

8. The perimeter access control system of claim 1, wherein said at least one drum further includes a tensioning system.

9. The perimeter access control system of claim 1, further including an alarm system.

10. The perimeter access control system of claim 9, wherein said alarm system includes a strain gauge affixed to said first portion of fencing, said strain gauge causing the alarm to sound if the tension of said first portion of fencing is decreased.

11. A method of forming a fenced perimeter around a secured area, the method comprising:
positioning a plurality of posts around the secured area;
positioning a portable base station proximate the secured area, the portable base station including at least one drum of fencing stored therein;
unwinding a first portion of fencing from the at least one drum, and wrapping the first portion of fencing around the plurality of posts;
attaching the first portion of fencing to each of the plurality of posts; and
after the first portion of fencing is wrapped around the plurality of posts, securing both ends of the first portion of fencing within the portable base station.

12. The method of claim 11, further comprising unwinding a second portion of fencing from a second drum.

13. The method of claim 12, wherein the first and second portions of fencing comprise a first cable and a second cable, respectively.

14. The method of claim 11, wherein at least one of the plurality of posts includes a clamping mechanism.

15. The method of claim 14, further comprising clamping the post proximate the secured area.

16. The method of claim 11, wherein the plurality of posts include eyelets.

17. The method of claim 16, further comprising securing the first portion of fencing in the eyelets.

18. The method of claim 11, further comprising storing the plurality of post on the portable base prior to positioning the posts around the secured area.

19. The method of claim 11, further comprising setting an alarm to detect tampering with the fenced perimeter.

20. The method of claim 19, further comprising placing a strain gauge on the first portion of fencing, enabling the alarm to detect if the first portion of fencing experiences a decrease in tension.
